(19) United States
(12) Patent Application Publication
(10) Pub. No.: US 2013/0220041 A1
(43) Pub. Date: Aug. 29, 2013

(54) VARIABLY OPERATED VALVE SYSTEM AND TIGHTENING STRUCTURE BETWEEN CONTROL SHAFT AND ACTUATOR OF VARIABLY OPERATED VALVE SYSTEM

(71) Applicants: Manabu KATAYAMA, Chigasaki-shi (JP); Katsushige YOSHIDA, Atsugi-shi (JP); Yoshihiko YAMADA, Fujisawa-shi (JP)

(72) Inventors: Manabu KATAYAMA, Chigasaki-shi (JP); Katsushige YOSHIDA, Atsugi-shi (JP); Yoshihiko YAMADA, Fujisawa-shi (JP)

(73) Assignee: HITACHI AUTOMOTIVE SYSTEMS, LTD.

(21) Appl. No.: 13/610,922

(22) Filed: Sep. 12, 2012

(30) Foreign Application Priority Data
Feb. 23, 2012 (JP) 2012-036889

(51) Int. Cl. F16H 25/16

(52) U.S. Cl. 74/54

(57) ABSTRACT

A variably operated valve system includes: a planar section cut out an outer peripheral surface of a control shaft in order for a linkage member to be grasped from an axial direction of the control shaft; a bolt hole drilled along a diameter direction of the control shaft via an oil passage from the planar section and having a female screw formed at a position of the control shaft which is an opposite side to the planar section; and a limitation section having a convexity section disposed on either one of the linkage member and the planar section and a recess section disposed on the other of the linkage member and the planar section to be fitted into the convexity section, a fixture bolt being screwed and tightened to the bolt hole via a bolt inserting hole of the linkage member to fix the linkage member to the control shaft.

### BACKGROUND OF THE INVENTION

(1) Field of the Invention

The present invention relates to a variably operated valve system which variably controls an operating characteristic of an engine valve(s) such as an intake valve(s) and an exhaust valve(s) of an internal combustion engine and a tightening structure between a control shaft and an actuator of the variably operated valve system.

(2) Description of Related Art

Recently, in a variably operated valve system which variably controls the operating characteristic of the engine valve, in order to accommodate to a layout characteristic within an engine compartment, an actuator of the variably operated valve system is disposed between cylinders of an internal combustion engine may be thought.

For example, a Japanese Patent Application First Publication No. 2009-150244 published on Jul. 9, 2009 (which corresponds to a U.S. Pat. No. 8,082,895 issued on Dec. 27, 2011) exemplifies a previously proposed variably operated valve system in which a projection section in which a female screw is formed on a control shaft to control an operation of the variably operated valve system is installed and a linkage member to which a power is transmitted from an actuator is tightened and fixed.

### SUMMARY OF THE INVENTION

However, the variably operated valve system described in the above-described Japanese Patent Application, a link arm makes a swing motion while approaching to a rear surface of the projection section along with a rotation of a drive cam. Therefore, it is necessary to perform a dimensional control for the rear surface of the projection section through a cutting in order to suppress an interference between the link arm and the projection section. Consequently, a manufacturing work becomes complicated and a high manufacturing cost is introduced.

It is, hence, an object of the present invention to provide an improved variably operated valve system and a tightening structure between a control shaft and an actuator of the variably operated valve system which are easy in a dimensional control for the control shaft.

According to one aspect of the present invention, there is provided a tightening structure between a control shaft and an actuator of a variably operated valve system, comprising: a drive shaft to which a rotating force is transmitted from a crankshaft; a drive cam integrally rotated with the drive shaft; the control shaft rotatably disposed and having an oil passage formed along an inner axial direction of the control shaft; an eccentric shaft eccentrically installed at a predetermined location of the control shaft with respect to a rotary center of the control shaft and to which oil is supplied from the oil passage; a linkage member having a bolt inserting hole and a fixture bolt inserted through the bolt inserting hole, the fixture bolt being tightened to a female screw hole installed on the control shaft to fix the linkage member to the control shaft; the actuator configured to give another rotating force to the control shaft via the linkage member; a rocker arm swingably disposed with the eccentric shaft as a center; a link arm configured to link the drive cam and the rocker arm to convert the rotating force of the drive cam into a swing motion of the rocker arm; a swing cam to which a swing force of the rocker arm is transmitted via a link rod in order for an engine valve to be operated in a valve open direction; a planar section configured to cut out an outer peripheral surface of the control shaft such that the linkage member is grasped from the axial direction of the control shaft; a bolt hole drilled along a diameter direction of the control shaft via the oil passage to from the planar section and at a position of which the female screw is formed and which is an opposite side to the planar section; and a limitation section constituted by a convexity section disposed on either one of the linkage member and the planar section and a recess section disposed on the other of the linkage member and the planar section to fit the recess section to the convexity section, wherein an inner diameter of a portion of the belt hole corresponding to the oil passage is set to be larger than an inner diameter of the oil passage and the fixture bolt is screwed and tightened to the bolt hole via the bolt inserting hole of the linkage member to fix the linkage member to the control shaft.

According to another aspect of the present invention, there is provided a tightening structure between a control shaft and an actuator of a variably operated valve system, comprising: a drive shaft to which a rotating force is transmitted from a crankshaft; a drive cam integrally rotated with the drive shaft; a control shaft rotatably installed and having an oil passage formed along an inner axial direction of the control shaft; an eccentric shaft eccentrically installed at a predetermined location of the control shaft with respect to a rotary center of the control shaft and to which oil is supplied from the oil passage; a linkage member having a bolt inserting hole and a fixture bolt inserted through the bolt inserting hole, the fixture bolt being tightened to a female screw hole installed on the control shaft to fix the linkage member to the control shaft; an actuator configured to give a rotating force to the control shaft via the linkage member; a rocker arm swingably disposed with the eccentric shaft as a center; a link arm configured to link the drive cam and the rocker arm to convert the rotating force of the drive cam to a swing motion of the rocker arm; and a swing cam to which a swing force of the rocker arm is transmitted via a link rod in order for an engine valve to be operated in a valve open direction; a planar section configured to cut out an outer peripheral surface of the control shaft in order for the linkage member to be grasped from the axial direction of the control shaft; a bolt hole drilled along a diameter direction of the control shaft via the oil passage from the planar section and at an opposite side of which the female screw of the control shaft is formed; and a limitation section disposed over the linkage member and the planar section to limit a movement of the linkage member in a shearing direction of the linkage member to the planar section, wherein an inner diameter of a portion of the belt hole corresponding to the oil passage is set to be larger than an inner diameter of the oil passage and the fixture bolt is screwed and tightened to the bolt hole via the bolt inserting hole of the linkage member to fix the linkage member to the control shaft.

According to a still another aspect of the present invention, there is provided a variably operated valve system, comprising: a drive shaft to which a rotating force is transmitted from a crankshaft; a drive cam integrally rotated with the drive shaft; a control shaft rotatably installed and having an oil passage formed along an inner axial direction of the control shaft; an eccentric shaft eccentrically installed at a predetermined location of the control shaft with respect to a rotary center of the control shaft and to which oil is supplied from the oil passage; a linkage member having a bolt inserting hole and a fixture bolt inserted through the bolt inserting hole, the fixture bolt being tightened to a female screw hole installed on the control shaft to fix the linkage member to the control shaft; an actuator configured to give a rotating force to the control shaft via the linkage member; a rocker arm swingably disposed with the eccentric shaft as a center; a link arm configured to link the drive cam and the rocker arm to convert the rotating force of the drive cam to a swing motion of the rocker arm; and a swing cam to which a swing force of the rocker arm is transmitted via a link rod in order for an engine valve to be operated in a valve open direction; a planar section configured to cut out an outer peripheral surface of the control shaft in order for the linkage member to be grasped from the axial direction of the control shaft; a bolt hole drilled along a diameter direction of the control shaft via the oil passage from the planar section and at an opposite side of which the female screw of the control shaft is formed; and a limitation section disposed over the linkage member and the planar section to limit a movement of the linkage member in a shearing direction of the linkage member to the planar section, wherein an outer diameter of the fixture bolt is set to be smaller than an inner diameter of the oil passage and the fixture bolt is screwed and tightened to the bolt hole via the bolt inserting hole of the linkage member to fix the linkage member to the control shaft.

### BRIEF DESCRIPTION OF THE DRAWINGS

FIG. 1 is an essential part exploded perspective view of a drive mechanism which is applicable to a variably operated valve system in a first preferred embodiment according to the present invention.

FIG. 2 is a cross sectional view representing a variable mechanism and the drive mechanism of the variably operated valve system in the first preferred embodiment shown in FIG. 1.

FIG. 3 is a cross sectional view representing a maximum valve lift control state by means of the variable mechanism and the drive mechanism in the first embodiment shown in FIG. 1.

FIG. 4 is an essential part perspective view of the variable mechanism in the first preferred embodiment shown in FIG. 1.

FIG. 5 is an essential part perspective view of the variable mechanism in the first preferred embodiment shown in FIG. 1.

FIGS. 6A and 6B are a plan view representing a planar section of a control shaft in the first embodiment shown in FIG. 1 and a cross sectional view of the planar section cut away along a line of A-A in FIG. 6A, respectively.

FIG. 7 is a laterally cross sectional view representing a state in which a linkage member is fixed onto the control shaft in the first embodiment shown in FIG. 1

FIG. 8 is a perspective view representing a state in which a rocker arm is inserted into the control shaft in the first embodiment shown in FIG. 1.

FIGS. 9A and 9B are a plan view representing a planar section of the control shaft in a second preferred embodiment according to the present invention and a cross sectional view of the control shaft cut away along a line of B-B in FIG. 9A, respectively.

FIG. 10 is a laterally cross sectional view representing a state in which a linkage member is fixed to the control shaft in the second embodiment shown in FIGS. 9A and 9B.

FIGS. 11A and 11B are a plan view of the planar section of the control shaft in a third preferred embodiment and a cross sectional view of the planar section cut away along a line C-C in FIG. 11A in the third embodiment, respectively.

FIG. 12 is a laterally cross sectional view representing a state in which the linkage member is fixed to the control shaft in the third embodiment shown in FIGS. 11A and 11B.

FIGS. 13A and 13B are a plan view representing the planar section of the control shaft in a fourth preferred embodiment according to the present invention and a cross sectional view cut away along a line D-D in FIG. 13A, respectively.

FIG. 14 is a laterally cross sectional view representing a state in which the linkage member is fixed to the control shaft in the fourth embodiment shown in FIGS. 13A and 13B.

### DETAILED DESCRIPTION OF THE INVENTION

Hereinafter, preferred embodiments of a variably operated valve system and a tightening structure between a control shaft and an actuator of the variably operated valve system will be described in details with reference to the drawings. In each of these embodiments, the present invention is applicable to an intake valve side of a multi-cylinder internal combustion engine and two-intake valves per cylinder are equipped in the engine.

### First Embodiment

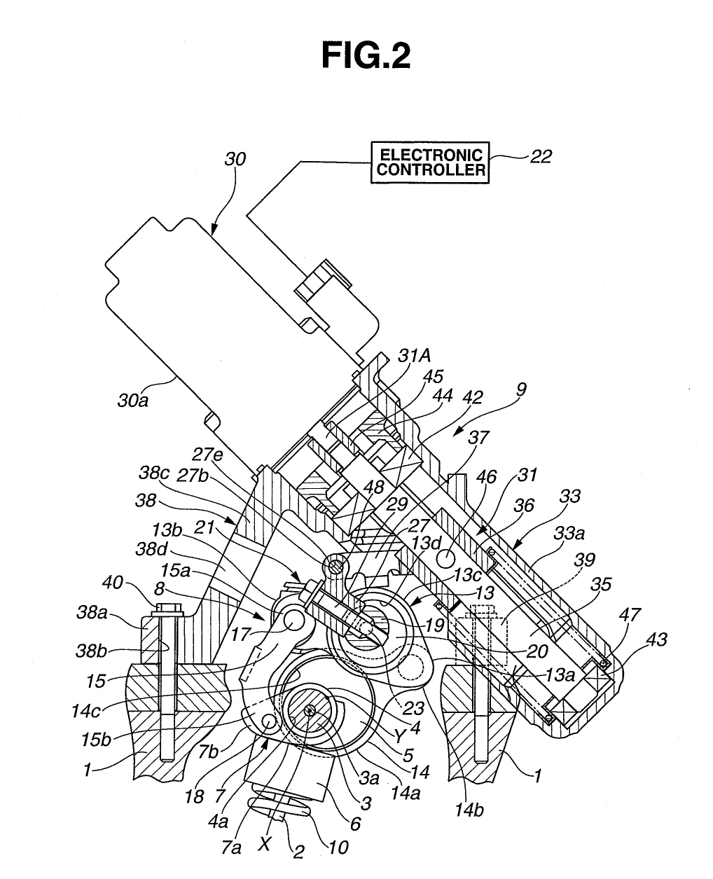

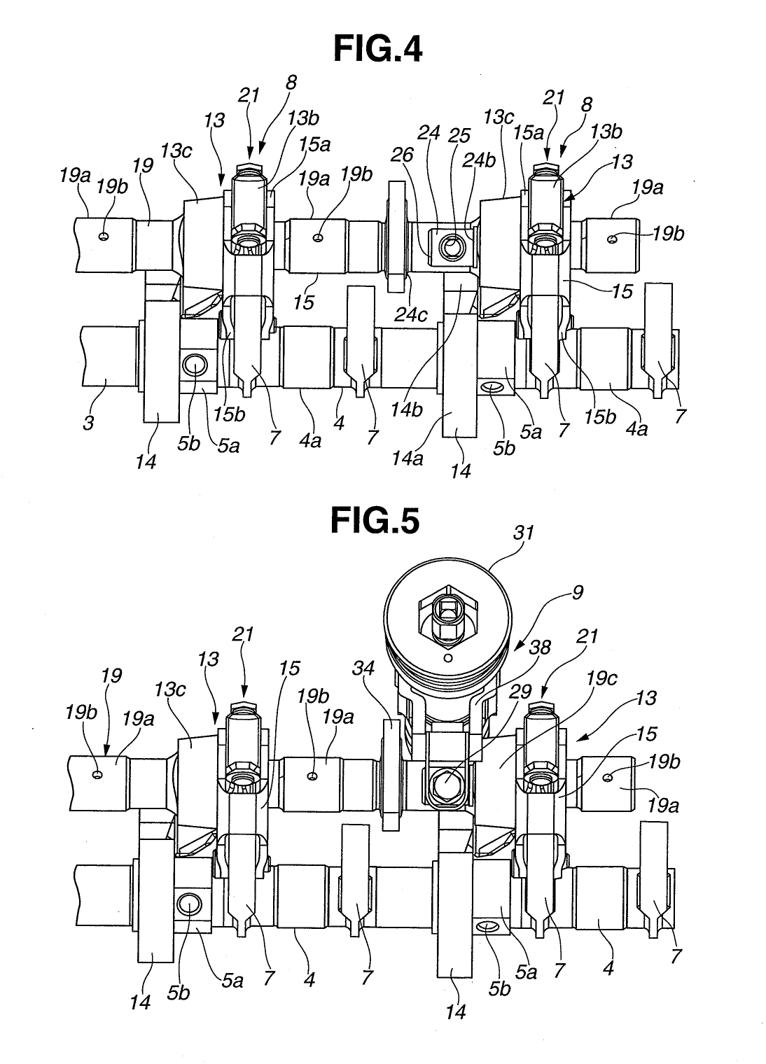

That is to say, in a first preferred embodiment of the variably operated valve system, the variably operated valve system, as shown in FIGS. 2 through 5, includes: a pair of intake valves 2, 2 per cylinder slidably installed on a cylinder head 1 via a valve guide (not shown); a hollow drive shaft 3 arranged along a forward-or-rearward direction of the engine; a cam shaft 4 disposed for each cylinder and rotatably and coaxially supported on an outer peripheral surface of drive shaft 3; a drive cam 5 integrally fixed onto a predetermined position of drive shaft 3; a pair of swing cams 7, 7 integrally mounted on both terminal ends of camshaft 4 and slidably contacted on valve lifters 6, 6 disposed on the upper ends of respective intake valves 2, 2; a transmission mechanism 8 interposed between drive cam 5 and swing cams 7, 7 to transmit a rotating force of drive cam 5 as a swing force (a valve open force); and a control mechanism 9 which makes an operation position of transmission mechanism 8 variable.

Intake valves 2, 2 are biased in their closure direction by means of valve springs 10, 10. Valve springs 10, 10 are elastically interposed between a bottom section of a bore and a spring retainer located at an upper end section of a valve stem. The bore is formed on an upper part of cylinder head 1. It should be noted that the variable mechanism is constituted .by drive shaft 3, camshaft 4, swing cam 7, transmission mechanism 8, and control mechanism 9.

Drive shaft 3 is arranged along the forward-and-backward direction of the engine. An oil passage hole 3a is formed in drive shaft 3 which communicates with a main oil gallery in an inner axial direction of drive shaft 3. An oil hole (not shown) is penetrated along a radial direction at a position of drive shaft 3 which corresponds to a journal section 4b of cam shaft 4. In addition, this drive shaft 3 is pivotally supported on a bearing (not shown) disposed at an upper part of cylinder head 1 and a rotating force is transmitted from a crankshaft of the engine via a driven sprocket (not shown) installed at an end section of drive shaft 3, a timing chain wound on the driven sprocket, and so forth.

Cam shaft 4 is formed substantially cylindrically along an axial direction of drive shaft 3 and a pivotal axis hole 4a rotatably supported on the outer peripheral surface of drive shaft 3 is penetrated in the inner axial direction. Journal section 4b in a cylindrical shape having a large diameter formed at a substantially center section of the outer peripheral surface is rotatably and axially supported on a camshaft bearing (not shown).

Drive cam 5 includes a drive cam main body formed in a substantially disc shape, an axis center Y of the cam main body being offset in a radial direction from axis center X of drive shaft 3 by a predetermined quantity. A cylindrical section 5a is integrally mounted on drive cam 5 in the axial direction of one side section of the cam main body. Drive cam 5 includes a fixture hole 5b drilled in the radial direction of cylindrical section 5a and a fixture pin (not shown) press fitted to a fixture hole of drive shaft 3 continuously formed on fixture hole 5b is used to fix drive cam 5 to drive shaft 3.

Respective swing cams 7, 7 provides approximately droplet shapes of the same configurations and have basic end portions which swing with an axial center of drive shaft 3 as a center via camshaft 4. Cam surfaces 7a are respectively formed on their lower surfaces of swing cams 7, 7 and are contacted on upper surface predetermined positions of respective valve lifters 6, 6. A pin hole is penetrated through a cam nose portion 7b at a tip of one of swing cams 7.

Transmission mechanism 8 includes: a rocker arm 13 disposed on an upper portion of drive shaft 3; a link arm 14 interlinked between one end section 13a of rocker arm 13 and drive cam 15; and a link rod 15 interlinked between the other end portion 13b of rocker arm 13 and one swing cam 7.

Rocker arm 13 includes a supporting hole 13d penetrated and formed from a lateral direction at an inner part of a cylindrical base portion 13c at a center thereof and is swingably supported on an outer periphery of a control cam 20 which will be described later via supporting hole 13d. In addition, one end section 13a of rocker arm 13 has a pin integrally projected on a side section of a tip of rocker arm 13 and the other end section 13b thereof is provided with a lift adjustment mechanism 21 configured to adjust a valve lift (quantity) of intake valves 12, 12 in relation to link rod 15.

Link arm 14 includes: a large-diameter annular section 14a; and a projection end 14b projected at a predetermined position on an outer peripheral surface of annular section 14a. A fitting hole is formed on a center section of annular section 14a into which an outer peripheral surface of drive cam 5 is rotatably fitted. A pin hole is penetrated projection end 14b. Pin 16 is rotatably inserted into the pin hole of projection end 14b.

Link rod 15 is formed in an approximately Japanese letter [symbol] shape (laterally inverted U shape) in cross sectional surface by a press fitting and its inner side thereof is folded in an approximately Japanese letter [symbol] shape (laterally inverted V shape) in cross sectional surface (parallel two sheets of plates) to intentionally give a compact structure and pin holes are penetrated respectively in lateral directions on two leg end sections 15a, 15b formed in approximately in letter a shape in a cross sectional surface.

In addition, link rod 15 includes two-leg shaped one end section 15a rotatably linked to the other end section 13b of rocker arm 13 via linkage pin 17 inserted into both pin holes and lift adjustment mechanism 21. On the other hand, the other section 15b thereof is rotatably linked to swing cam 7 via respective pin holes and linkage pins 18 inserted into pin holes 7c formed at cam nose section 7b of one swing cam 7.

Lift adjustment mechanism 21 includes: a block-formed linkage section integrally formed at the other end section 13b of rocker arm 13; a lock-purpose screw screwed into a female screw hole (not shown) formed on an inner portion of the linkage section from an upper surface of the linkage section; and an adjustment screw screwed into the female screw hole from the lower side of the female screw. During the assembly of respective components of the variable mechanism, the adjustment screw is rotated so that an open valve quantity of each of the swing cams is fine adjusted by varying a length of link rod 15 for the linkage section.

Control mechanism 9 includes: a hollow control shaft 19 disposed at an upper position of drive shaft 3; a control cam 20 which is an eccentric shaft integrally fixed on an outer periphery of control shaft 19 and which is a swing fulcrum of rocker arm 13; a driving mechanism which rotatably controls control shaft 19; and an electronic controller 22 which is control means for controlling driving mechanism 24 in accordance with an engine driving condition.

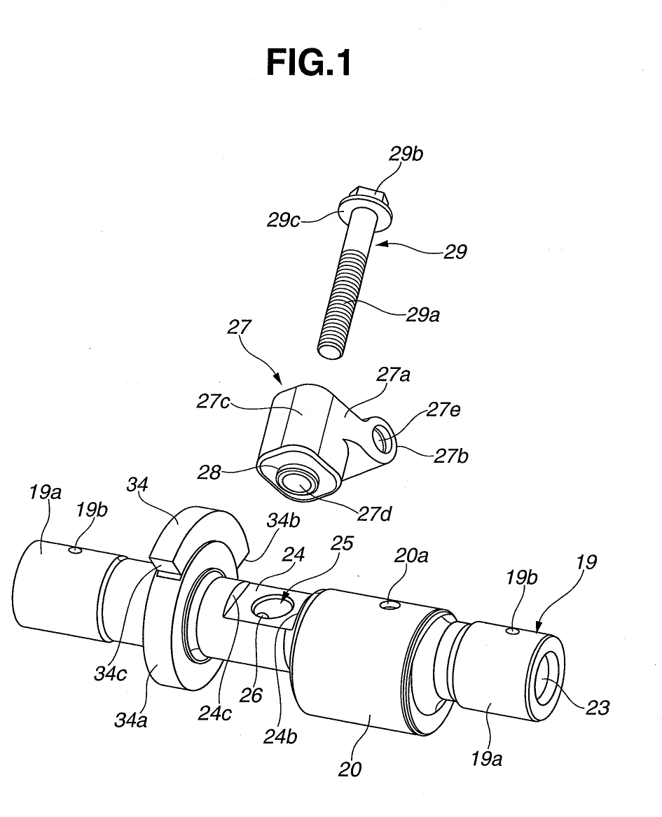

Control shaft 19 is, as shown in FIGS. 1 through 5, disposed in an engine forward-and-backward direction in parallel to drive shaft 3 and is rotatably supported via a bearing section (not shown) disposed on an upper end section of cylinder head 1. An oil passage (a passage hole) 23 is formed in an inner axial center direction of control shaft 19. In addition, a passage hole 19b of control shaft 19 to communicate with oil passage 23 through a radial direction thereof is formed at a position which provides a journal section 19a supported on the bearing section of control shaft 10. Thus, a space between journal section 19a and the bearing section is effectively lubricated with the lubricating oil passage 27. It should be noted that the bearing section serves also as a bearing for drive shaft 3 at its lower side.

In addition, control shaft 19, as shown in FIGS. 1, 4, 6A, 6B, and 7, includes: a planar section 24 integrally disposed such that an outer peripheral surface of control shaft 19 is cut out at a predetermined middle position of control shaft 19 in the axial direction of control shaft 19.

That is to say, this planar section 24 includes: a flat seat surface 24a in a rectangular shape disposed at a substantially middle position between two cylinders in the axial direction of control shaft 19 in a substantially orthogonal direction to an axial line of control shaft 19; and rising (or starting) opposing surfaces 24b, 24c in a two-surface width shape formed at both ends of flat seat surface 24a in the axial direction of control shaft 19.

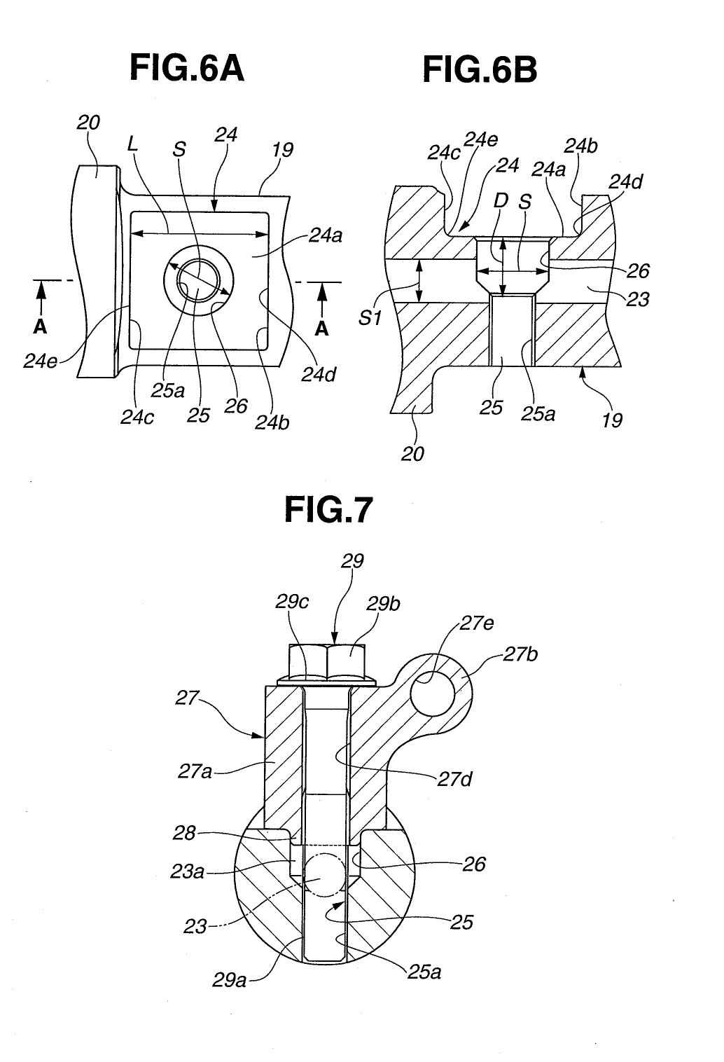

Seat surface 24a, as shown in FIGS. 6A and 6B, is a cut out surface of the outer peripheral surface of control shaft 19 from a tangential (line) direction formed in a substantially square shape, is set so that one side length (axial length) is a predetermined length L and bolt hole 25 is drilled through a substantial center position of planar section 24.

Rising (or starting) opposing surfaces 24b, 24c are formed by cutting out both ends of seat surface 24a and are formed in an arc shape along an outer peripheral surface of control shaft 19. Coupling sections (portions) 24d, 24e between respective lower end edges and both end edges of seat surface 24a are chamfered.

Bolt hole 25 is penetrated along a diameter direction of control shaft 19 and is formed in a state in which its axis is orthogonal to oil passage 23. In addition, bolt hole 25 is, as shown in FIGS. 6A through 7, formed with a cylindrical fitting groove 26 constituting a part of a limitation section as will be described later as a position of bolt hole 25 at seat surface 24a side and a female hole 25a is formed at a position opposite to seat surface 24a. In addition, fitting groove 26 has its depth D set to a depth to the bottom surface of oil passage 23 and an inner diameter S is set to be larger than inner diameter of oil passage 23. Hence, this fitting groove 26 secures a communication characteristic in the axial direction without the closure of oil passage 23 by means of bolt 29.

In addition, a linkage member 27 is fixed onto planar section 24 of control shaft 19 to link control shaft 19 with a ball nut as will be described later. This linkage member 27 is, as shown in FIG. 1 and FIG. 7, mainly constituted by a main body 27a formed in a substantially square tubular shape having a square shape in cross section; and a linkage supporting section 27b integrally mounted on an upper end section of main body 27a.

Main body 27a has four corner sections 27c, a to surface of each corner section being formed in an arc shape. A bolt inserting hole 27d is penetrated in a vertical direction of linkage member 27. In addition, this main body 27a has its one side length L1 set to be slightly smaller than a length between two-surface width formed opposing surfaces 24b, 24c of planar section 24 of control shaft 19. When main body 27a is fitted into planar section 24, linkage member 27 is grasped between opposing surfaces 24b, 24c via both ends of the lower end sections.

Linkage supporting section 27b is formed substantially in a cylindrical shape and is extended along a direction substantially orthogonal to main body 27a and a pin hole 27e is penetrated in the inner axial direction.

In addition, a fitting convexity section 28 is integrally disposed on a hole edge of bolt inserting hole 27d located at a center lower end surface of main body 27a to constitute a part of the above-described limitation section.

This fitting convexity section 28 is, as shown in FIG. 1 and FIG. 7, formed in a cylindrical shape and bolt inserting hole 27d is continuously formed at the center of this fitting groove 26 of control shaft 19 and its outer diameter fitting convexity section is formed to be slightly smaller than the inner diameter of fitting groove 26 of control shaft 19 so that fitting convexity section 28 is fitted to fitting groove 26. The fitting state of fitting convexity section 28 to this fitting groove 26 is obtained so that a movement of linkage member 27 to planar section 24 in a shearing direction of linkage member 27 is limited. It should be noted that a chamfering is carried out to obtain a favorable fitting action to fitting groove 26 on a lower end outer periphery of fitting convexity section 28.

Fixture bolt 29 includes a male screw 29a screwed to female screw hole 25a of bolt hole 25 at a tip section side of its axle section; and a head section 29b having a flange seat surface 29c at an upper end section.

Hence, when linkage member 27 is fixed to planar section 24, as shown in FIG. 7, the lower end section of main body 27a is grasped and retained between opposing surfaces 24c, 24d while fitting convexity section 28 of linkage member 27 is fitted into fitting groove 26, and, thereafter, fixture bolt 29 is inserted into bolt inserting hole 27d and bolt hole 25 and is tightened via female screw hole 25a and male screw 29a so that linkage member 27 is strongly fixed to planar section 24. That is to say, a shaft force of fixture bolt 29, a grasping action by means of opposing surfaces 24b, 24c, and the fitting of fitting convexity section 28 into fitting groove 26 permits a strong fixture of linkage member 27 on planar section 24. In details, an accurate positioning and a strong fixture state of linkage member of control shaft 19 without deviation in any of the axial direction, the diameter direction, and the radial direction to control shaft 19.

At this time, as shown in FIG. 7, when fixture bolt 29 is inserted into a bolt hole 25, a gap hole 23a is formed between the outer peripheral surface of a shank section of fixture bolt 29 and the inner peripheral surface of fitting groove 26. Hence, a communication characteristic of the axial direction of oil passage 23 can be secured.

A sector shaped stopper piece 34 is installed via a flange section 34a at a side section of planar section 24 in the axial direction of control shaft 19. This stopper piece limits a maximum leftward-or-rightward rotational direction of control shaft 19. Flange section 34a has a lower half section which is rotatably fitted into a semi-arc groove (not shown) formed at the upper end section of cylinder head 1 in a non-contact state and, on the other hand, an angular length of stopper piece 34 in a circumferential direction is set at about 90°. Along with a normal-or-reverse directional rotation of control shaft 19, flange section 34a is accordingly rotated in the normal-or-reverse direction. At this time, either one of both end edges 34b, 34c is contacted on either one end edges of the semi-arc shaped groove so that the further rotation of control shaft 19 is limited. In details, when both side (end) edges 34b, 34c are contacted on both side edges of the semi-arc shaped groove, a maximum leftward-or-rightward rotational position of control shaft 19 is limited.

On the other hand, control cam 20 provides a cylindrical form and its axial center position of control cam 20 is offset by a predetermined distance from the axial center of control shaft 19 (by a thickness portion). An axial width W of control cam 20 us formed to have a slightly larger than a length in width of cylindrical base section 13c of rocker arm 13 (a length of width of supporting hole 13d). Thus, an axial drop of rocker arm 13 during the operation is limited. In addition, an oil hole 20a communicated with oil passage 23 is formed along an inner radial direction of control cam 20.

Oil passage 23 is communicated with the oil main gallery at which lubricating oil pressurized and supplied from an oil pump (not shown) is supplied to each slide section (of the engine). Oil passage 23 is communicated with a supporting hole 13d of a cylindrical base section 13c of rocker arm 13 (a length of width of cylindrical base portion 13c of rocker arm 13) via an oil hole 20e continuously formed in the inner direction of control shaft 19 and control cam 20 along the radial direction, in addition to passage hole 19b. Hence, an effective lubrication between the outer peripheral surface of control cam 20 and the inner peripheral surface of the supporting hole is made with the lubricating oil supplied from oil passage 23.

The driving mechanism is, as shown in FIGS. 2, 3, and 5, arranged and fixed in a slant shape on the upper end section of cylinder head 1 at which linkage member 27 is placed along an engine width direction which is between the cylinders of the center section in the elongate direction of the engine. The driving mechanism is mainly constituted by: an electrically operated motor 30 arranged at one end side of the driving mechanism; and a ball screw transmission mechanism 31 arranged at the other end side of the driving mechanism which is a reduction mechanism which decelerates the rotating driving force of electrically operated motor 30.

Electrically operated motor 30 is constituted by a proportional DC motor including electromagnetic coils and rotor (not shown) housed at an inside of a motor casing 20a and is driven through a control current outputted from electronic controller 22 detecting a driving state of the engine.

Electronic controller 22 performs a feedback of detection signals from various types of sensors such as a potentiometer and so forth to detect a rotation position of control shaft 19, a crank angle sensor to detect an engine (rotational) speed, an airflow meter to detect an intake air quantity, and a coolant temperature sensor to detect an engine coolant temperature, and to detect a present engine driving condition through which various kinds of logic operations and to output a control signal to electrically operated motor 30.

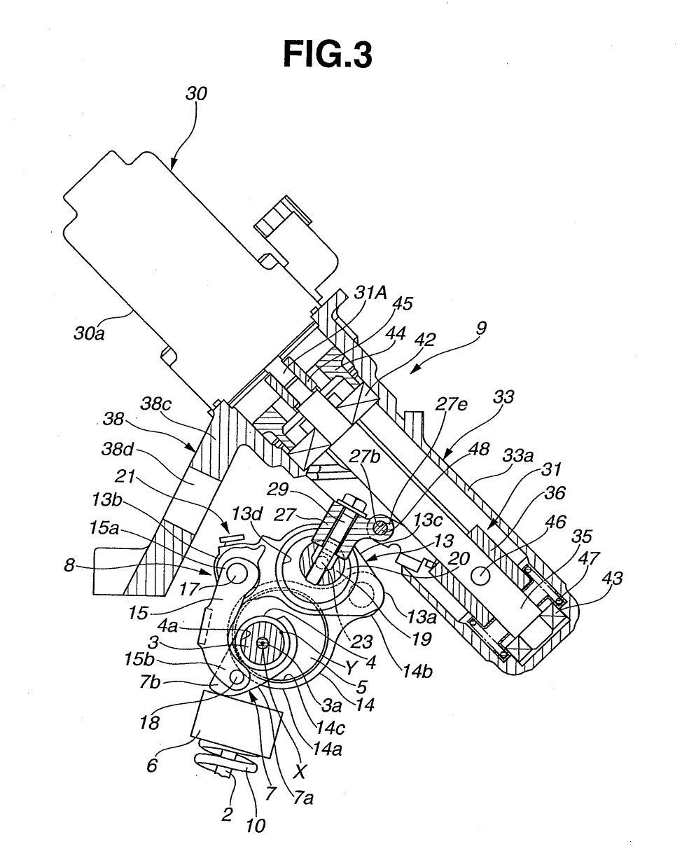

Ball screw transmission mechanism 31 is, as shown in FIGS. 2 and 3, mainly constituted by: a housing 33 coupled to motor casing 30a from the axial direction; a ball screw shaft 35 housed within an inside of housing 33 and which provides an output shaft of motor 30 arranged approximately coaxially with a drive shaft 31A of electrically operated motor 30; a ball nut 36 which is a movement member screwed to an outer periphery of ball screw shaft 35; and a linkage arm 37 linking via linkage member 27 between ball nut 36 and control shaft 19.

Above-described housing 33 is constituted by an approximately cylindrical housing main body 34a housed within ball screw shaft 35 as shown in FIGS. 1 through 5 and first and second brackets 38, 39 fixed on the upper end portion of cylinder head 1, as appreciated from FIGS. 1 though 5.

First bracket 38 is formed in an approximately Japanese letter of [symbol] shape (laterally inverted V shape) in cross section as shown in FIGS. 2 and 3. Bolt penetrating holes 38b, 38b through which a pair of bolts 40, 40 are inserted to be engageably tightened and fixed onto cylinder head 1 are penetrated vertically through and formed at both sides of a lower end portion 38a in a long block shape. In addition, in first bracket 38, a working purpose hole 38d having a relatively large diameter is vertically penetrated through and formed at an approximately center position of an upper end section 38c formed in a plate-like form to pass a fixture bolt 29 to fix linkage member 27 to planar section 24.

On the other hand, second bracket 39 is integrally disposed at both side sections of housing main body 34a and bolt inserting holes 39a, 39a through which a pair of bolts 41, 41 are inserted are vertically penetrated for second bracket 39 to be tightened and fixed onto cylinder head 1.

Hence, the above-described driving mechanism is arranged so as to cross over a part of the variable mechanism including swing cams 7, 7 and transmission mechanism 8 via respective brackets 38, 39 from an upper section of the variable mechanism.

Ball screw shaft 35 has a ball circulating groove (not shown) spirally and continuously formed which is a screw section having a predetermined width over a whole outer peripheral surface except both end sections of ball screw shaft 35. Both end sections exposed respectively to one end opening section of housing 33a faced toward electrically operated motor 30 and to a small-diameter section of the other end section of housing 34a are rotatably journalled by means of first and second ball bearings 42, 43.

First ball bearing 42 located at the side of electrically operated motor 30 has a plurality of balls rollably disposed in a one-row ball groove, an outer peripheral surface of an outer lace being fixed under pressure into an inside of one end section, and first ball bearing 42 is axially positioned by means of a bearing cap 44. On the other hand, second ball bearing 43 located at a tip side has the approximately same structure as first ball bearing 42 and has a plurality of balls rollably installed in a one-row ball groove, an outer peripheral surface of the outer lace being fixed under pressure in an inside of a small-diameter portion of another end wall.

Furthermore, one end section of ball screw shaft 35 is formed on an approximately square shape in cross sectional surface, as shown in FIGS. 1 and 2. Ball screw shaft 35 is coaxially movably linked with the tip of drive shaft 31A of electrically operated electric motor 30 by means of a linkage member 45. Such a linkage as described above causes a rotating driving force of electrically operated member 30 to be transmitted to ball screw shaft 35.

Ball nut 36 is formed approximately in a cylindrical shape, has a guide groove to hold rollably the plurality of balls in association with the ball circulating groove spirally and continuously formed on an inner peripheral surface thereof, and has two deflectors attached for the circular rows of the plurality of balls to be set at front and rear positions of the axial direction of ball nut 36.

Ball nut 36 provides an axial movement force while converting a rotational movement of ball screw shaft 35 into a linear movement. In addition, ball nut 36 is rotatably linked with one end section of linkage arm 37 by means of a pivotal support pin 46 at an approximately a center position in the axial direction of ball nut 36.

In addition, an axial movement range of ball nut 36 is limited to a predetermined range by means of stopper piece 34 which limits the maximum revolution of control shaft 19. Ball nut 36 is set as follows: that is to say, intake valves 2, 2 provide minimum valve lifts at a position (a position shown in FIG. 2) by which ball nut 36 is moved toward the electrically operated motor side and provide maximum valve lifts at a position (a position shown in FIG. 3) by which ball nut 36 is moved toward second ball bearing 43 maximally.

A coil spring 47 which constitutes biasing means and is elastically interposed between a housing step-difference surface of ball nut 36 provided on a side of second ball bearing 43 and a spring retainer installed on one end section of ball nut 36 serves to bias ball nut provided on a side of second ball bearing 43 and a spring retainer installed on one end section of ball nut 36 serves to bias ball nut 36 toward electrically operated motor 30. At the position at which the maximum position is obtained, head section 29b of fixture bolt 29 is set to be exposed through working purpose hole 38d of first bracket 38.

Linkage arm 37 is formed by means of a press-fit, folded in an approximately Japanese letter of [symbol] shape, and is formed in a two-sheet forms in an elongated straight line. One end section of linkage arm 37 is rotatably linked to ball nut 36 by means of pivotal support (linkage) pin 46 installed at ball nut 36 and the other end of linkage arm 37 is rotatably linked to linkage member 27 via a linkage pin 48 inserted into pin hole 27e provided in a linkage supporting section 27b of linkage member 27. Thus, an axial movement force of ball nut 36 is transmitted as a force to normally-or-reversely rotate control shaft 19.

Hereinafter, a variable action of valve lifts (quantities) (of intake valves 2, 2) by means of the variable mechanism will briefly be described.

First, for example, when the engine is rotated at a low revolution area of the engine, electronically operated motor 30 is rotatably driven according to a control current outputted from electronic controller 22. This rotation torque is transmitted to ball screw shaft 35 to be revolved so that ball nut 36 is moved toward the position shown in FIG. 2. At this time, this movement force is transmitted to control shaft 19 via linkage arm 37 and linkage member 27. At this time, control shaft 19 is rotatably driven in a uni-direction so that control shaft 19 is limited to the maximum rotation position in the unit-direction as shown in FIG. 2 by means of stopper section 53b.

Hence, control cam 20 is pivoted in the uni-direction and its axial center of control cam 20 is revolved with the same radius and a thickness section thereof is spatially separated from drive shaft 3 and moved in the upward direction from drive shaft 3. This causes other end section 13b of rocker arm 13 and an axial (pivotal) support point (linkage pin 17) of link rod 15 are moved in the upward direction to drive shaft 3. Thus, a cam nose side of each swing arm 7 is forcibly pulled up via link rod 15.

Hence, when drive cam 5 is rotated so that one end section 13a of rocker arm 13 is pushed upward via link arm 14, its lift quantity is transmitted to each swing cam 7 and each valve lifter 6. However, the lifts (lift quantities) of intake valves 2, 2 are sufficiently small.

Furthermore, in a case where the engine is transferred to a high rotation area, electrically operated motor 30 is reversely rotated according to a control shaft current from electronic controller 22 so that ball screw shaft 35 is revolved in the same direction. At this time, along with this rotation, control shaft 19 rotates control cam 20 in the other direction so that the axial center thereof is moved in the lower direction. Thus, whole rocker arm 13 is, in turn, moved in the direction of drive shaft 3 so that the other end section 13b of rocker arm 13 causes a cam nose section of each swing cam 7 to be pressed in the lower direction via link rod 15. Thus, the whole of each swing cam 7 is pivoted in the counterclockwise direction from the position shown in FIG. 2 by a predetermined quantity. Hence, as shown in FIG. 3, a contact position of cam surface 7a of each swing cam 7, 7 for an upper surface of each valve lifter 6 is moved at the cam nose section side (a lift section side).

Therefore, when drive cam 5 is rotated during the open operation of each of intake valves 2, 2 (engine valve) so that one end section 13a of rocker arm 13 is pushed upwardly via link arm 14 and valve lifts (lift quantities) of intake valves 2, 2 are made large via respective valve lifters 6.

In addition, during a stop of the engine, ball nut 36 is biased and held at the minimum valve lift position shown in FIG. 1 according to the spring force of coil spring 47. Hence, a re-start characteristic of the engine becomes favorable.

Then, according to this embodiment, the driving mechanism is not arranged at the end section in the axial direction of control shaft 19 but is arranged at a middle position in the axial direction described above. Thus, the elongation of the variable system in the axial direction can be suppressed and easiness in mounting of the system on the vehicle can be improved.

Then, control shaft 19 is linked with linkage arm 37 of ball nut 36 via linkage member 27 and fixture bolt 29 which are simple in structure. Hence, an increase in the number of parts can be suppressed. The manufacturing work and assembly work can be facilitated. A cost reduction can also be achieved.

Since only planar section 24 is formed on the outer peripheral surface of control shaft 19 and such a projection section as described in the previously proposed variably operated valve system of the U.S. Pat. No. 8,082,895 (the Japanese Patent Application First Publication No. 2009-150244) is not formed, an interference with a component of the variably operated valve system such as a link arm 14 operated on the outer peripheral side of control shaft 19 can be suppressed. Thus, it becomes unnecessary to make a cutting on the back surface of control shaft 19 and the dimensional control becomes unnecessary. Consequently, the manufacturing work becomes easy and the reduction in the manufacturing cost can be achieved.

In addition, in order to fix linkage member 27 by means of fixture bolt 29 to planar section 24 of control shaft 19, the lower end section of main body 27a of linkage member 27 is grasped and retained from the axial direction between opposing surfaces 24b, 24c and fitting convexity section 28 is fitted into fitting (recess) groove 26 so as to provide, a so-called mating structure. Thus, the positioning of linkage member 27 to planar section 24 becomes extremely easy and, in this state, a strong coupling of linkage member 27 to control shaft 19 can be achieved by tightening of bolt 29 to linkage member 27 and control shaft 19.

When linkage member 27 is fixed with the bolt to planar section 24, the lower end section of main body 27a of linkage member 27 is grasped and held between opposing surfaces 24b, 24c and, at the same time, fitting convexity section 28 is fitted into fitting groove 26 in order to assuredly limit the movement in the shear direction. Thus, an appropriate positioning can be achieved.

Bolt hole 25 of control shaft 19 is penetrated and formed in the diameter direction. Thus, the drilling work through a drill can be facilitated.

In addition, for example, during an attachement of linkage mechanism 27 onto control shaft 19, the spring force of coil spring 47 causes ball nut 36 to be held at the position shown in FIG. 1 which provides the minimum valve lift. Thus, the axial center of working purpose hole 38c of first bracket 38, bolt inserting hole 49b of linkage plate 33, and female screw hole 28b of projection portion 28 are approximately on the same straight line. Therefore, the spiral attaching operation from an outside of fixture bolt 48 through working purpose hole 38c onto female screw hole 28b can be easily be carried out. Thus, a working efficiency of assembling each component can be improved.

In addition, the fixture of linkage member 27 to planar section 24 is carried out through fixture bolt 29 so that not only easiness in the fixing work but also the strong fixture state can be achieved.

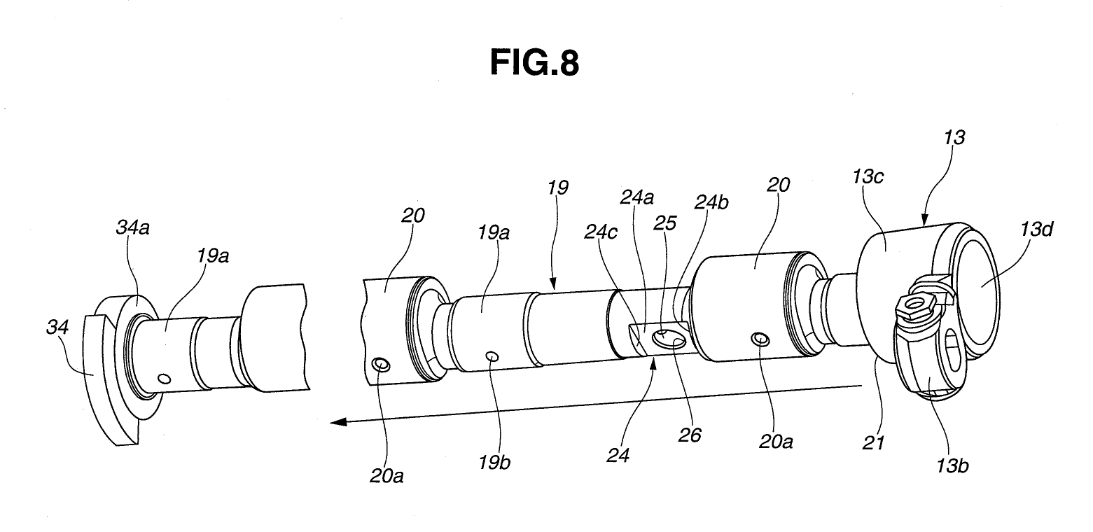

Since no projection section is present on the outer peripheral surface of control shaft 19 other than stopper piece 34 located at the center position of control shaft 19 in the axial direction thereof, for example, as shown in FIG. 8, each rocker arm 13 can be fitted and inserted to corresponding control cam 20, for example, as shown in FIG. 8, when each rocker arm 13 is assembled to corresponding one of control cams 20. Hence, the assembly operation of each rocker arm 13 can be facilitated.

Furthermore, fixture bolt 29 is inserted through oil passage 23 of planar section 19 from its diameter direction of control shaft 19. However, as described above, the passage area can be secured by means of fitting groove 26 which has a larger diameter than oil passage 23. Hence, a flow resistance of oil within oil passage 23 can sufficiently be suppressed.

Furthermore, bolt hole 25 of planar section 24 is extended to oil passage 23. Hence, lubricating oil is introduced between female screw section 29a of fixture bolt 29 and bolt hole 25 of planar section 24. Thus, an adherence due to a rust of fixture bolt 29 can be prevented.

The driving mechanism such as electrically operated motor 30 is disposed between respective cylinders, namely, between respective variably operated valve systems in which no other parts are present. Hence, an effective use of dead space can be achieved.

### Second Embodiment

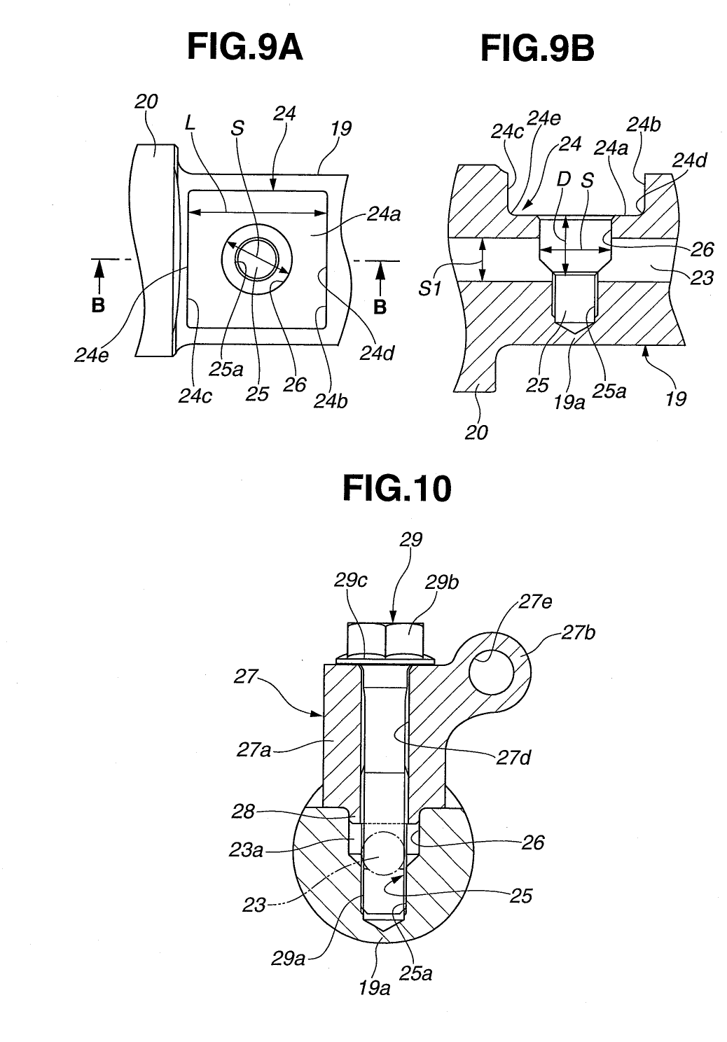

FIGS. 9A, 9B, and 10 show a second preferred embodiment of the variably operated valve system. In the second embodiment, bolt hole 25 of planar section 24 is not penetrated through control shaft 19 but formed through oil passage 23 and until a midway through control shaft 19. It should be noted that reference numeral 19a shown in FIGS. 9B and 10 denotes a bottom section of control shaft

The other structure is the same as the first embodiment. Hence, the same action and the same effect can be obtained. In addition, the lower end section of bolt hole 25 is closed. Thus, a leakage of oil from oil passage 23 can be suppressed.

### Third Embodiment

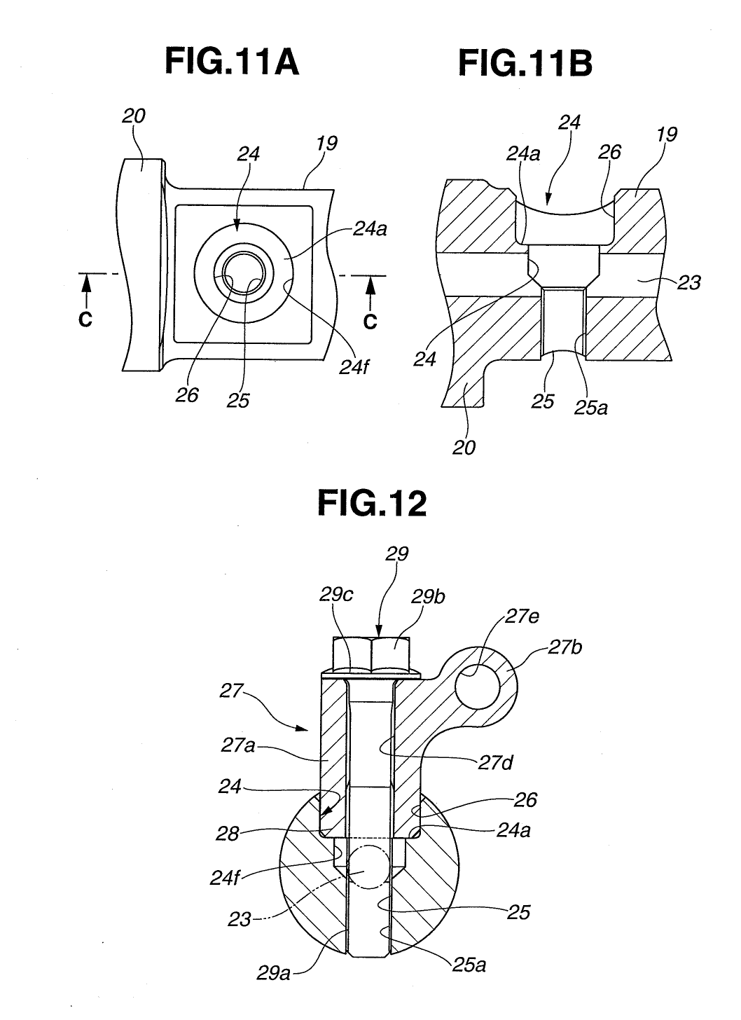

FIGS. 11A, 11B, and 12 show a third preferred embodiment of the variably operated valve system according to the present invention. In the third embodiment, planar section 24 is not in the rectangular shape but is formed in a circular shape. A corresponding linkage member 27 is formed in the cylindrical shape.

That is to say, planar section 24 is cut out in a substantially cylindrical deep groove shape on the outer peripheral surface of control shaft 19. Planar section 24 includes a seat surface 24a which is the flat bottom surface formed in the circular shape and a wall surface 24f raised from the outer peripheral edge of seat surface 24a. In addition, a whole of planar section 24 is constituted as fitting groove 26 which is a fitting recess section and bolt hole 25 is penetrated in the diameter direction of control shaft 19 at the center of seat surface 24a and female screw 25a is formed at the tip section of bolt hole 25.

Furthermore, a communicating groove 24f having a larger inner diameter than oil passage 23 is formed at a position of planar section 24 which is lower than seat surface 24a. Oil within oil passage 23 is caused to flow through a space formed between the inner peripheral surface of communicating groove 24f and an outer peripheral surface of fixture bolt 29.

On the other hand, linkage member 27 includes a linkage member main body 27a in a cylindrical shape having a uniform outer diameter. The lower end section of linkage member is constituted as fitting convexity section 28 fitted to fitting groove 26. A linkage supporting section 27b having pin hole 27e on the inner section of an upper end side section of main body 27a is integrally disposed on linkage member 27.

The other structures of female screw hole 25a of bolt hole 25 and oil passage 23 are the same as the first embodiment.

Hence, the same action and effects as those of the first embodiment can be obtained. Since planar section 24 and fitting groove 26 are integrated together and main body 27a of linkage member 27 and fitting convexity section 28 have the mutually same outer diameter and are integrated. Hence, the manufacturing work of these parts is easy and the drilling is carried out for planar section 24 and fitting groove 26 so that the manufacturing work becomes easy.

### Fourth Embodiment

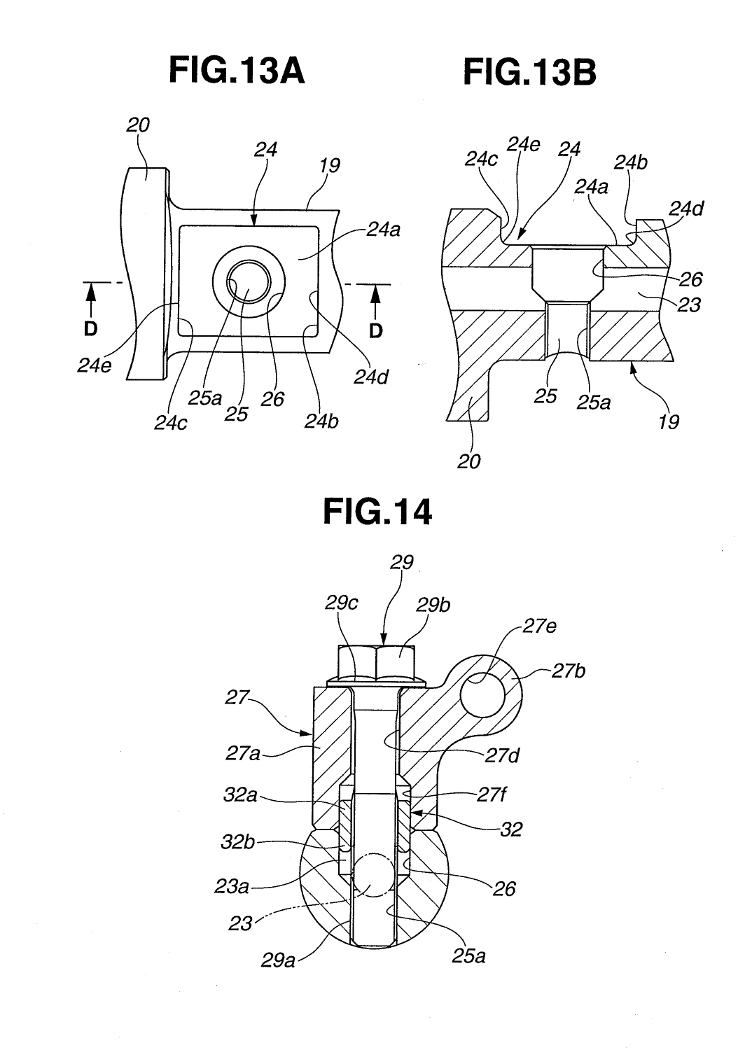

FIGS. 13A, 13B, and 14 show a fourth preferred embodiment of the variably operated valve system according to the present invention.

Each structure of planar section 24 of control shaft 19 and fitting groove 26 is the same as described in the first embodiment. However, a second fitting groove 27f which is a recess groove opposing against first fitting groove 26 from the vertical direction is formed on the lower end section of bolt inserting hole 27d of linkage member 27 at planar section 24 side. This second fitting groove 27f is formed in a substantially cylindrically and an inner diameter and depth of second fitting groove 27f are generally set to be the same as those of first fitting groove 26.

In addition, a limitation section 32 is pressed into a space between first and second fitting grooves 26, 27f. This limitation section 32 is formed in the cylindrical shape and an axial length of limitation section 32 is set to be shorter (smaller) than the axial length of each of first and second fitting grooves 26, 27f. An outer diameter of this limitation section is formed to be slightly larger than the inner diameter of second fitting groove 27f. An upper end section 32a of limitation section 32 is previously pressed into second fitting groove 27f.

When linkage member 27 is fixed to planar section 24, lower end section 32b of limitation section 32 is fitted into first fitting groove 26 to perform a positioning. Limitation section 32 serves to limit the movement in the shear direction of linkage member 27 by means of limitation section 32.

Hence, in this embodiment, favorable action and effects can be achieved. That is to say, the appropriate and accurate positioning and the improvements in the manufacturing workability and in a dimension efficiency can be achieved in the same way as the first embodiment.

The present invention is not limited to the structure of each embodiment. For example, as the limitation section, other than the cylindrical fitting convexity section as in the first embodiment, the projection can intermittently be provided in the circumferential direction. In addition, other than intake valves 2, 2, the present invention is applicable to the exhaust valve side.

The technical ideas of the present invention other than the independent claims will, hereinafter, be described.

(1) The tightening structure between the control shaft and the actuator of the variably operated valve system as set forth in claim 1, wherein the convexity section is disposed on the linkage member and the recess section is disposed on the planar section.
(2) The tightening structure between the control shaft and the actuator of the variably operated valve system as set forth in item (1), wherein the convexity section is projected in a cylindrical shape and the recess section is opened cylindrically on a hole edge section of the bolt hole exposed to a flat surface of the planar section.
(3) The tightening structure between the control shaft and the actuator of the variably operated valve system as set forth in claim 1, wherein starting opposing surfaces in a shape of a width across flat are formed on both end sections of the planar section in an axial direction of planar section.
(4) The tightening structure between the control shaft and the actuator of the variably operated valve system as set forth in item (3), wherein the starting opposing surfaces in the shape of the width across flat serve to limit a free revolution of the linkage member about the bolt inserting hole.
(5) The tightening structure between the control shaft and the actuator of the variably operated valve system as set forth in item (4), wherein the convexity section disposed on the linkage member is formed in a cylindrical shape and extended along an axial direction of the bolt inserting hole of the linkage member.
(6) The tightening structure between the control shaft and the actuator of the variably operated valve system as set forth in item (5), wherein the convexity section is formed in a column shape of a square.
(7) The tightening structure between the control shaft and the actuator of the variably operated valve system as set forth in claim 1, wherein the bolt hole is penetrated through the control shaft.
(8) The tightening structure between the control shaft and the actuator of the variably operated valve system as set forth in claim 1, wherein a bottom section is formed between the oil passage and an outer peripheral surface of the control shaft and the bolt hole is formed not to be penetrated through the control shaft by a presence of the bottom section.
(9) The tightening structure between the control shaft and the actuator of the variably operated valve system as set forth in claim 10, wherein the limitation section is structured by fitting the linkage member over recess grooves formed respectively on the linkage member and the planar section.
(10) The tightening structure between the control shaft and the actuator of the variably operated valve system as set forth in item (9), wherein the limitation section is formed in a cylindrical shape and each of the recessed grooves is formed in the cylindrical shape corresponding to the limitation section.
(11) The tightening structure between the control shaft and the actuator of the variably operated valve system as set forth in item (10), wherein starting opposing surfaces in a shape of a width across flat are formed at both sides of the planar section of the control shaft in an axial direction of the control shaft.
(12) The tightening structure between the control shaft and the actuator of the variably operated valve system as set forth in item (11), wherein the opposing surfaces in the shape of the width across flat serve to limit a free revolution of the linkage member shaft about the bolt inserting hole of the linkage member.
(13) The tightening structure between the control shaft and the actuator of the variably operated valve system as set forth in claim 10, wherein a supporting wall is disposed on a whole periphery of the planar section and the linkage member fitted into the supporting wall to structure the limitation section.
(14) The tightening structure between the control shaft and the actuator of the variably operated valve system as set forth in claim 10, wherein the actuator is interposed between cylinders of a multi-cylinder internal combustion engine.
(15) The variably operated valve system as set forth in claim 17, wherein the actuator comprises: an electrically operated motor; an output shaft rotationally driven by means of the electrically operated motor; a movement member configured to be moved along an axial direction of the output shaft in accordance with a revolution of the output shaft; and a linkage arm configured to link swingably between the movement member and the linkage member.
(16) The variably operated valve system as set forth in item (15), wherein the movement member is a ball nut.
(17) The variably operated valve system as set forth in item (16), wherein the actuator is interposed between cylinders of a multi-cylinder internal combustion engine.

This application is based on a prior Japanese Patent Application No. 2012-36889 filed in Japan on Feb. 23, 2012. The entire contents of this Japanese Patent Application No. 2012-36889 are hereby incorporated by reference. Although the invention has been described above by reference to certain embodiments of the invention, the invention is not limited to the embodiment described above. Modifications and variations of the embodiments described above will occur to those skilled in the art in light of the above teachings. The scope of the invention is defined with reference to the following claims.

What is claimed is:

1. A tightening structure between a control shaft and an actuator of a variably operated valve system, comprising:
a drive shaft to which a rotating force is transmitted from a crankshaft;
a drive cam integrally rotated with the drive shaft;
the control shaft rotatably disposed and having an oil passage formed along an inner axial direction of the control shaft;
an eccentric shaft eccentrically installed at a predetermined location of the control shaft with respect to a rotary center of the control shaft and to which oil is supplied from the oil passage;
a linkage member having a bolt inserting hole and a fixture bolt inserted through the bolt inserting hole, the fixture bolt being tightened to a female screw hole installed on the control shaft to fix the linkage member to the control shaft;
the actuator configured to give another rotating force to the control shaft via the linkage member;
a rocker arm swingably disposed with the eccentric shaft as a center;
a link arm configured to link the drive cam and the rocker arm to convert the rotating force of the drive cam into a swing motion of the rocker arm;
a swing cam to which a swing force of the rocker arm is transmitted via a link rod in order for an engine valve to be operated in a valve open direction;
a planar section configured to cut out an outer peripheral surface of the control shaft such that the linkage member is grasped from the axial direction of the control shaft;
a bolt hole drilled along a diameter direction of the control shaft via the oil passage from the planar section and at a position of which the female screw is formed and which is an opposite side to the planar section; and
a limitation section constituted by a convexity section disposed on either one of the linkage member and the planar section and a recess section disposed on the other of the linkage member and the planar section to fit the recess section to the convexity section,
wherein an inner diameter of a portion of the belt hole corresponding to the oil passage is set to be larger than an inner diameter of the oil passage and the fixture bolt is screwed and tightened to the bolt hole via the bolt inserting hole of the linkage member to fix the linkage member to the control shaft.

2. The tightening structure between the control shaft and the actuator of the variably operated valve system as claimed in claim 1, wherein the convexity section is disposed on the linkage member and the recess section is disposed on the planar section.

3. The tightening structure between the control shaft and the actuator of the variably operated valve system as claimed in claim 2, wherein the convexity section is projected in a cylindrical shape and the recess section is opened cylindrically on a hole edge section of the bolt hole exposed to a flat surface of the planar section.

4. The tightening structure between the control shaft and the actuator of the variably operated valve system as claimed in claim 1, wherein starting opposing surfaces in a shape of a width across flat are formed on both end sections of the planar section in an axial direction of planar section.

5. The tightening structure between the control shaft and the actuator of the variably operated valve system as claimed in claim 4, wherein the starting opposing surfaces in the shape of the width across flat serve to limit a free revolution of the linkage member about the bolt inserting hole.

6. The tightening structure between the control shaft and the actuator of the variably operated valve system as claimed in claim 5, wherein the convexity section disposed on the linkage member is formed in a cylindrical shape and extended along an axial direction of the bolt inserting hole of the linkage member.

7. The tightening structure between the control shaft and the actuator of the variably operated valve system as claimed in claim 6, wherein the convexity section is formed in a column shape of a square.

8. The tightening structure between the control shaft and the actuator of the variably operated valve system as claimed in claim 1, wherein the bolt hole is penetrated through the control shaft.

9. The tightening structure between the control shaft and the actuator of the variably operated valve system as claimed in claim 1, wherein a bottom section is formed between the oil passage and an outer peripheral surface of the control shaft and the bolt hole is formed not to be penetrated through the control shaft by a presence of the bottom section.

10. A tightening structure between a control shaft and an actuator of a variably operated valve system, comprising:
a drive shaft to which a rotating force is transmitted from a crankshaft;
a drive cam integrally rotated with the drive shaft;
a control shaft rotatably installed and having an oil passage formed along an inner axial direction of the control shaft;
an eccentric shaft eccentrically installed at a predetermined location of the control shaft with respect to a rotary center of the control shaft and to which oil is supplied from the oil passage;
a linkage member having a bolt inserting hole and a fixture bolt inserted through the bolt inserting hole, the fixture bolt being tightened to a female screw hole installed on the control shaft to fix the linkage member to the control shaft;
an actuator configured to give a rotating force to the control shaft via the linkage member;
a rocker arm swingably disposed with the eccentric shaft as a center;
a link arm configured to link the drive cam and the rocker arm to convert the rotating force of the drive cam to a swing motion of the rocker arm; and
a swing cam to which a swing force of the rocker arm is transmitted via a link rod in order for an engine valve to be operated in a valve open direction;
a planar section configured to cut out an outer peripheral surface of the control shaft in order for the linkage member to be grasped from the axial direction of the control shaft;
a bolt hole drilled along a diameter direction of the control shaft via the oil passage from the planar section and at an opposite side of which the female screw of the control shaft is formed; and
a limitation section disposed over the linkage member and the planar section to limit a movement of the linkage member in a shearing direction of the linkage member to the planar section, wherein an inner diameter of a portion of the belt hole corresponding to the oil passage is set to be larger than an inner diameter of the oil passage and the fixture bolt is screwed and tightened to the bolt hole via the bolt inserting hole of the linkage member to fix the linkage member to the control shaft.

11. The tightening structure between the control shaft and the actuator of the variably operated valve system as claimed in claim 10, wherein the limitation section is structured by fitting the linkage member over recess grooves formed respectively on the linkage member and the planar section.

12. The tightening structure between the control shaft and the actuator of the variably operated valve system as claimed in claim 11, wherein the limitation section is formed in a cylindrical shape and each of the recessed grooves is formed in the cylindrical shape corresponding to the limitation section.

13. The tightening structure between the control shaft and the actuator of the variably operated valve system as claimed in claim 12, wherein starting opposing surfaces in a shape of a width across flat are formed at both sides of the planar section of the control shaft in an axial direction of the control shaft.

14. The tightening structure between the control shaft and the actuator of the variably operated valve system as claimed in claim 13, wherein the opposing surfaces in the shape of the width across flat serve to limit a free revolution of the linkage member shaft about the bolt inserting hole of the linkage member.

15. The tightening structure between the control shaft and the actuator of the variably operated valve system as claimed in claim 10, wherein a supporting wall is disposed on a whole periphery of the planar section and the linkage member fitted into the supporting wall to structure the limitation section.

16. The tightening structure between the control shaft and the actuator of the variably operated valve system as claimed in claim 10, wherein the actuator is interposed between cylinders of a multi-cylinder internal combustion engine.

17. A variably operated valve system, comprising:
a drive shaft to which a rotating force is transmitted from a crankshaft;
a drive cam integrally rotated with the drive shaft;
a control shaft rotatably installed and having an oil passage formed along an inner axial direction of the control shaft;
an eccentric shaft eccentrically installed at a predetermined location of the control shaft with respect to a rotary center of the control shaft and to which oil is supplied from the oil passage;
a linkage member having a bolt inserting hole and a fixture bolt inserted through the bolt inserting hole, the fixture bolt being tightened to a female screw hole installed on the control shaft to fix the linkage member to the control shaft;.
an actuator configured to give a rotating force to the control shaft via the linkage member;
a rocker arm swingably disposed with the eccentric shaft as a center;
a link arm configured to link the drive cam and the rocker arm to convert the rotating force of the drive cam to a swing motion of the rocker arm; and
a swing cam to which a swing force of the rocker arm is transmitted via a link rod in order for an engine valve to be operated in a valve open direction;
a planar section configured to cut out an outer peripheral surface of the control shaft in order for the linkage member to be grasped from the axial direction of the control shaft;
a bolt hole drilled along a diameter direction of the control shaft via the oil passage from the planar section and at an opposite side of which the female screw of the control shaft is formed; and
a limitation section disposed over the linkage member and the planar section to limit a movement of the linkage member in a shearing direction of the linkage member to the planar section,
wherein an outer diameter of the fixture bolt is set to be smaller than an inner diameter of the oil passage and the fixture bolt is screwed and tightened to the bolt hole via the bolt inserting hole of the linkage member to fix the linkage member to the control shaft.

18. The variably operated valve system as claimed in claim 17, wherein the actuator comprises: an electrically operated motor; an output shaft rotationally driven by means of the electrically operated motor; a movement member configured to be moved along an axial direction of the output shaft in accordance with a revolution of the output shaft; and a linkage arm configured to link swingably between the movement member and the linkage member.

19. The variably operated valve system as claimed in claim 18, wherein the movement member is a ball nut.
